(19) United States
(12) Patent Application Publication
(10) Pub. No.: US 2016/0004977 A1
(43) Pub. Date: Jan. 7, 2016

(54) Content Monetization System

(71) Applicants: Jiazheng Shi, Campbell, CA (US); Fei Pan, (US); Boogoo Intellectual Property LLC, Westlake Village, CA (US)

(72) Inventors: Jiazheng Shi, Campbell, CA (US); Fei Pan, Cupertino, CA (US)

(73) Assignee: Boogoo Intellectual Property LLC, Westlake Village, CA (US)

(21) Appl. No.: 14/789,993

(22) Filed: Jul. 2, 2015

Related U.S. Application Data
(60) Provisional application No. 62/020,920, filed on Jul. 3, 2014.

(51) Int. Cl. G06N 99/00; G06Q 20/12

(52) U.S. Cl. CPC G06N 99/005; G06Q 20/123

(57) ABSTRACT

A system and method are provided to monetize content by redacting the content with machine learning algorithms. This invention increases the conversion rate of website surfers to paid customers. Extracted texts of the content are tokenized and then scored with normalized value [0, 1] to measure their significance. Intra-token, inter-token, extra-token, and tagged token features are used to characterize each individual token. Scores of sentences, paragraphs, sections, and even chapters can be calculated with various methods based on the scores of tokens. Then, the content is redacted according to the calculated scores. Customers can view the redacted content for free. If interested, they can purchase the content and view the full, non-redacted version of the content. The present invention is useful in publication and monetization of digital contents such as e-books.

### CROSS-REFERENCE TO RELATED APPLICATIONS

This application claims priority to U.S. Provisional Patent Application Ser. No. 62/020,920, filed Jul. 3, 2014, the entire contents of which are incorporated herein by reference.

### FIELD OF INVENTION

This invention relates to a method and system for monetizing digital content by redacting portions of the content.

### BACKGROUND OF THE INVENTION

The publication industry has been using paywalls to bring in revenue by providing valuable content to Internet users. A paywall is a system that prevents Internet users from accessing web page content without payment. Traditionally, paywalls may be implemented based on either subscription model or metered model. With the subscription model, readers are unable to access any content without payment. With the metered model, readers can enjoy, for example, a limited number of articles per month, or the sampling of several pages of a book or paragraphs of an article. Another payment model is the pay-per-view model, where a user can purchase a particular piece of content to read or enjoy without any subscription.

Small website owners or freelance bloggers may write infrequently or may not have big name reputation. Accordingly, they may not be able to attract enough Internet users to purchase their content via monthly subscription or metered model. The pay-per-view model may be a better option for them. However, one problem with pay-per-view is that Internet users may not have a good overview of the content at issue if sufficient detail is not disclosed. In that case, they may not be interested enough to pay for the content. On the other hand, if too much detail is revealed, it may defeat the purpose of the pay-per-view process.

Thus, there is a need for a system which can automatically redact content yet leaving enough detail to attract readers to purchase the whole content.

### SUMMARY OF THE INVENTION

This invention provides a system to monetize digital content by redacting portions of the content with machine learning natural language processing (NLP) algorithms. In one embodiment, the system first tokenizes the content into tokens. A token can be either a word or a phrase. A score for each token is calculated and normalized with computer algorithms. Features such as intra-token, inter-token, extra-token, and tagged-token are used to characterize and score each token. Scores of sentences, paragraphs, sections, and chapters can be calculated with flexible aggregation methods.

The system also allows a content provider to customize a preview of content, such as the type of information to be shown, the amount of information visible to users before they pay, and the method to render the redacted portions of the content.

In another embodiment of the invention, the system automatically selects portions of content to be redacted without any intervention from the content provider. Thus, a content provider cannot predict which portions of its content will be rendered invisible to potential viewers. This approach helps to reduce fraud and build trust between content providers and consumers.

This invention may be applied to all text-containing digital content, including but not limited to HTML files, PDF files, and other text-containing documents.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the leftmost digit of a reference number identifies the drawing in which the reference number first appears.

FIG. 1 is a system diagram showing the content monetization system, in accordance with an embodiment of the present invention.

FIG. 2 is a flow diagram showing a process of redacting text-containing content, in accordance with an embodiment of the present invention.

FIG. 3 is a flow diagram showing a process for payment management, according to an embodiment of the present invention.

FIG. 4 shows a web page including an article redacted according to the present invention.

### DETAILED DESCRIPTION

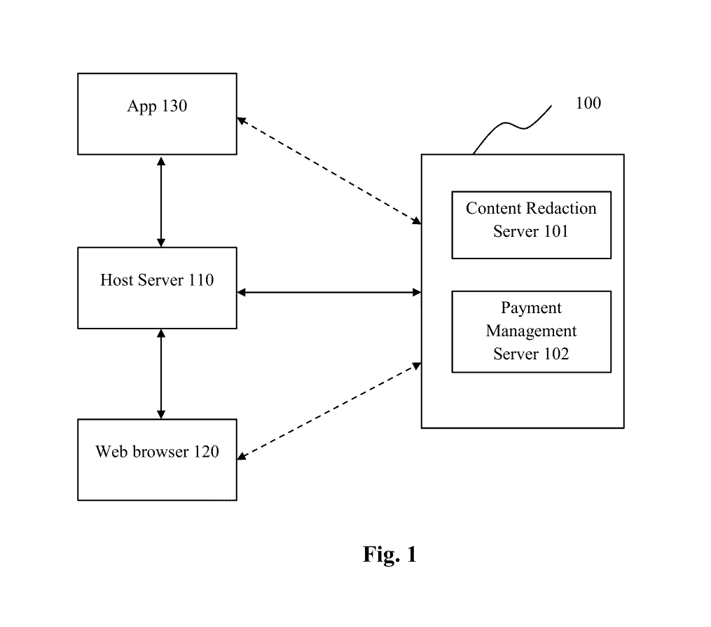

FIG. 1 is a system diagram showing the content monetization system 100 (hereinafter “the System 100”). In one embodiment, the System 100 includes a content redaction server 101 and a payment management server 102. The content redaction server 101 directly or indirectly receives content (e.g., a web page, article, eBook) from a host server 110, extracts text from the content, decides which portions of the text to redact and how to redact, and generates a redacted version of the content. The host server 110 may decide to send the content to the content redaction server 101 because the content contains redaction flag, such as a unique symbol or mark, indicating that the provider of the content would like to redact part of the content. The redacted version of the content may be sent back to the host server 110 or stored in a data warehouse of the System 100 (not shown in FIG. 1) or a third party system. When a consumer browses the content via a web browser 120 or an application 130 (e.g., smartphone application), the redacted version of the content is sent to the browser 120 or application 130 for display, unless the consumer has paid for the content. For example, the consumer may purchase the content via the payment management server 102. After payment is processed, the original content (i.e., the non-redacted version) is sent to the web browser 120 or application 130.

The System 100 may be implemented with one or more computers. Also, the System 100, or part of it, may be integrated into the host server 110. Alternatively, the System 100 may be a standalone service that can serve multiple host servers.

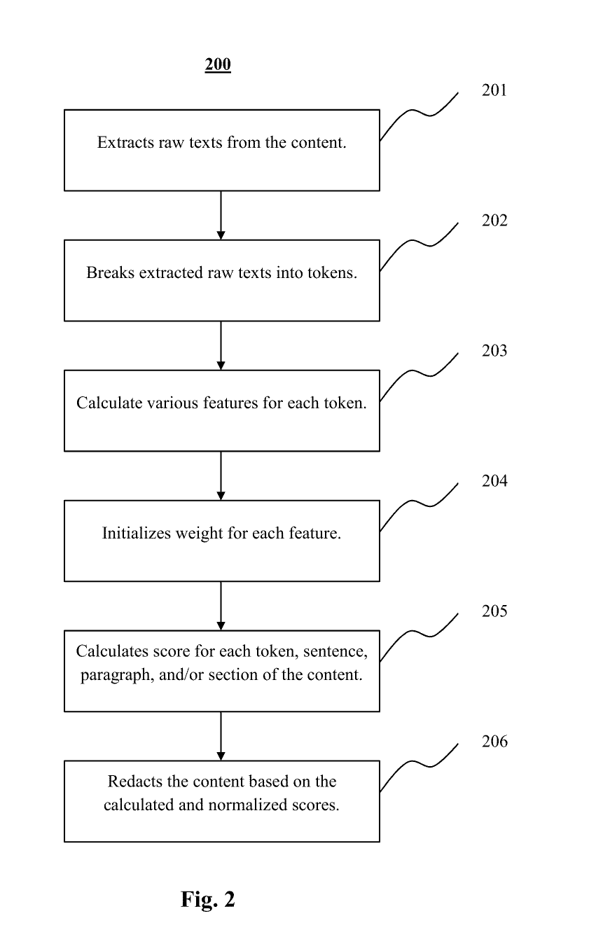

FIG. 2 is a flow diagram showing a process (200) of redacting text-containing content, in accordance with an embodiment of the present invention. One or more instances of the process 200 may run on the content redaction server 101.

At step 201, the process 200 extracts raw texts from the content. Raw texts are part of the original content for consumers to read or enjoy. In one embodiment, the text-containing content is web-based content, such as web pages, which may include other types of media (e.g., image, video, audio). Web-based content typically uses markup languages such as HTML and XHTML for annotation. Various tags are used for achieving certain functions, including formatting content styles, controlling browsers, communicating with web servers, updating content dynamically, storing temporary data, and so on. The redaction process is applied only to raw texts of the web-based content. Markup tags or other annotations in the web-based content remain untouched.

In one embodiment, extraction of raw texts can be implemented by using Document Object Model (DOM) tree parsing and tree traversal techniques. Alternatively, it may be implemented by searching annotation tags linearly and sequentially in the content string. For example, HTML tags are defined by characters “<” and “>”. They can be closed using separate closing tags or using self-closing syntax. Server-side script languages, including PHP and JSP, also use characters “<” and “>” to identify their tags. In some platforms, such as WordPress™, there are some reserved tags that are identified by square bracket “[” and” “]”. The process 200 searches and adds guard tags to make the raw text extraction process consistent and stable. For example, if some untagged sections need to be kept intact, the system adds guard tags, for example, “<shortcode>” for WordPress™ plugins, to ensure that such information is not touched. For HTML web page, the process 200 excludes non-content sections (e.g., JavaScript code, Cascading Style Sheets (CSS) code, noscript, and CDATA sections) from processing. The process 200 may also be configured to keep HTML headers or any pre-selected sections untouched.

At step 202, the process 200 breaks extracted raw texts of the content into tokens. A token can be a word or phrase. In one embodiment, the process 200 may use existing tokenization tools, such as Apache's OpenNLP™, for the tokenization task. Alternatively, the process 200 can tokenize the extracted raw texts by detecting whitespace and punctuation marks.

After tokenization, the process 200 calculates a score for each token. The score measures the importance of a token in the current content. For example, a score can be defined from 0 (which has the least significant value) to 1 (which has the most significant value). Note that this scoring strategy may be relevant only within a particular piece of content itself, or be extended to multiple pieces or batches of content.

In one embodiment, a random score can be assigned to either all tokens or all selected tokens (for example, excluding stop words). This redaction method is straightforward, requiring low computational cost. However, it does not favor key information in the content, so it is inefficient in hiding key information and motivating web surfers to pay for content.

In another embodiment, a more sophisticated scoring approach is used. As discussed below, the process 200 includes feature extraction, feature selection, and feature combination. The process 200 can be optimized in terms of conversion rate with training data collected from live products. One definition of conversion rate (CR) in this invention is

Conversion Rate=Number of Paid Views/Number of Page views×100%

At step 203, the process 200 calculates various features for each token. These features include, but are not limited to, intra-token feature, inter-token feature, extra-token feature, and tagged-token feature.

The intra-token feature Fᵢₙₜᵣₐ of a token measures the significance or importance of the token in and of itself. It is determined by the token itself and is independent of the context where the token appears. In one embodiment, the Fᵢₙₜᵣₐ value of a token is a function (e.g., aggregation) of the entropies of all letters in the token:

x=f(hᵢ),iε{1, . . . ,n},

where hᵢ is the entropy of the token's i^{th} letter, assuming there are n letters in the token, and f(.) can be any function, including, but not limited to, summation or weighted summation. Entropy measures information in content as a function of the amount of uncertainty as to what is in the content. Mathematically, entropy h can be formulated as follows:

h=−E{log(p)}

where p stands for the probability of outcome and E{.} stands for statistical expectation. The entropy of a letter (“a,” “b,” etc.) may be predetermined based on the type of a natural language (English, Dutch, etc.) or a particular field (e.g., medical, legal, finance), or it may be calculated dynamically based on a set of data that may change from time to time. Once determined, the Fᵢₙₜᵣₐ value can be normalized into the range of [0, 1] as follows:

$${x}_{0 , 1} = \frac{x - {x}_{min}}{{x}_{max} - {x}_{min}} ,$$

where xₘₐₓ and xₘᵢₙ are the max and min values of this feature in the content. Also, the value can be normalized statistically to have the Normal distribution N(0,1) as follows:

$${x}_{0 , 1} = \frac{x - \underline{x}}{σ} ,$$

where x and σ are the mean and standard deviation, respectively. Methods such as thresholding by percentiles, e.g., 5% and 95% percentile as the min and max values, can help avoid outliers. Furthermore, certain information (e.g., social security number, government ID number, bank/credit card account number) may be detected based on preset format (e.g., 9-digit with dashes for SSN, 16-digit for credit card) and may be given higher Fᵢₙₜᵣₐ value.

The inter-token feature Fᵢₙₜₑᵣ of a token measures the significance or importance of the token within a particular context. The Fᵢₙₜₑᵣ value may be determined based on an objective factor and/or a subjective factor. And the objective factor may be determined based on the estimated importance of the token within the context where the token appears. For example, the objective factor may be computed by an automatic keyword (or keyphrase) extraction algorithm or tool (e.g., Python's RAKE library, AlchemyAPI's keyword extraction API) which analyzes a token and its context and returns a value (between 0 and 1) representing the estimated importance of the token within the context. The process 200 can use the value as the objective factor for the Fᵢₙₜₑᵣ value.

The subjective factor may be computed by using existing algorithms (such as the ones developed by Stanford Natural Language Processing Group) to analyze and extract sentiment of the token. A token having polite, positive sentiment may have a high score between 0 and 1, whereas a token having negative sentiment may have a low score between 0 and 1, or vice versa if the redaction purpose is to hide negative content.

Specifically, let pₒ and pₛ be the objective and subjective factors of the token x, the token's Fᵢₙₜₑᵣ value may be characterized as follows:

Fᵢₙₜₑᵣ=f(pₒ,pₛ) where 0≦pₒ,pₛ≦1

f(pₒ, pₛ) can be a linear combination, such as Fᵢₙₜₑᵣ=0.5*pₒ+0.5*pₛ. Alternatively, it may be a nonlinear function or even a trained neural network or other computational approaches.

The extra-token feature Fₑₓₜᵣₐ of a token measures the significance or importance of the token in terms of general public interest. In one embodiment, the System 100 maintains a list of such tokens (e.g., political topics, taboo expressions, popular search words) in a lookup table. If a token is in this list, the Fₑₓₜᵣₐ value of the token may be 1. Otherwise, the Fₑₓₜᵣₐ value of the token may be 0. In another embodiment, the Fₑₓₜᵣₐ value of a token can be determined in terms of popularity, sensitivity, or other ranking factors. For example, the System 100 can maintain the order of entries adaptively to reflect the trend in social media or search engines or other media indexing services. The System 100 can normalize the rank to quantitative value in [0, 1]. For example, let N be the total number of entries in the table and r be the rank of a given token:

$${F}_{extra} = \frac{N - r}{N - 1} , r ∈ \{ 1 , … , N \}$$

If the token is the on the top (r=1), Fₑₓₜᵣₐ=1.0 while the last one has Fₑₓₜᵣₐ=0. Other linear or nonlinear formula may be used for measuring the score. For example, the System 100 may impose minimal score to Fₑₓₜᵣₐ instead of using 0.

The tagged-token feature F_{tagged} of a token measures the significance or importance of the token to a particular content provider. A content provider can tag a token to indicate that the tagged token is significant in some respect. For example, a content provider can use the “<b>” or “<em>” HTML tag to bold or emphasize text. Of course, the System 100 may define its own tags for such purpose. Furthermore, the System 100 may maintain a list of such tagged tokens for each content provider. The F_{tagged} value of a token may be 1 or 0. A value of 1 indicates that the token is tagged or belongs to the list of tagged tokens. A value of 0 indicates that the token is not tagged. In another embodiment, the F_{tagged} value of a token may be determined by ranking, such as the one used for determining Fₑₓₜᵣₐ.

At step 204, the process 200 initializes weight for each feature. In one embodiment, the process 200 uses the same weight for all selected features. Computer algorithms such as stepwise feature selection can be used for selecting features. Alternatively, a content provider may customize these weights. For example, a stock market reporter may give a relatively heavier weight to tagged-token feature for tokens related to stock prices, indices, and earnings. A feature may have a zero weight if the feature is not selected. After initialization or customization, the weights can be further optimized in terms of conversion rate or other metrics.

Prior linguistic and existing knowledge regarding natural languages (e.g., English, Dutch, Chinese) may be used to initialize certain parameters of the algorithms mentioned above, such as the OpenNLP™ algorithms. The process 200 may be optimized in terms of various performance metrics. For example, the process 200 may be optimized to achieve a certain level of conversion rate. The feature combination step may be optimized based on active learning or other semi-supervised learning methods. And A/B testing or cross-validation may be used to validate the optimization.

The process 200 may apply various regression methods or modeling paradigms to combine these features. For example, the process 200 may apply the following logistic regression function for a given performance metric (PM), such as conversion rate:

$$P M = \frac{{e}^{{α}_{0} + {α}_{1} * f ( {F}_{intra} ) + {α}_{2} * f ( {F}_{inter} ) + {α}_{3} * f ( {F}_{extra} ) + {α}_{4} * f ( {F}_{tagged} )}}{1 + {e}^{{α}_{0} + {α}_{1} * f ( {F}_{intra} ) + {α}_{2} * f ( {F}_{inter} ) + {α}_{3} * f ( {F}_{extra} ) + {α}_{4} * f ( {F}_{tagged} )}}$$

where f(.) is a function that aggregates all values of the given features in the content, αᵢ, i={0, 1, 2, 3,4} are weights. Here, f(.) may be mean, median, or other aggregation functions. In one embodiment, the process 200 can be trained with a large dataset so that the weights αᵢ, i={0, 1, 2, 3,4}, can be adjusted towards better performance.

At step 205, the process 200 calculates the score for each token, sentence, paragraph, and/or section of the content. With the optimized weights, a token's score is calculated as follows:

$$T = \frac{{e}^{{α}_{0} + {α}_{1} * {F}_{intra} + {α}_{2} {F}_{inter} + {α}_{3} * {F}_{extra} + {α}_{4} * {F}_{tagged}}}{1 + {e}^{{α}_{0} + {α}_{1} * {F}_{intra} + {α}_{2} {F}_{inter} + {α}_{3} * {F}_{extra} + {α}_{4} * {F}_{tagged}}}$$

The score has a range of [0, 1]. Based on token scores, the process 200 may calculate scores for sentences, paragraphs, and sections. For example, let tᵢ¹, . . . tᵢⁿ be scores of n tokens in a sentence i, the score for sentence i can be computed by function:

sᵢ=ƒ(tᵢ¹, . . . ,tᵢⁿ),

where ƒ(.) can be max, mean, media, or other aggregation functions. Similarly, the score for a paragraph can be calculated and normalized based on the scores of all sentences in the paragraph, and the score for a section can be calculated and normalized based on the scores of all paragraphs in the section, by using similar or different functions.

At step 206, the process 200 redacts the content based on the calculated and normalized scores. Content redaction can be based on tokens, sentences, paragraphs, or sections. The higher the information's score is the more important the information is. Thus, information (e.g., token, sentence, paragraph, section) with the highest score should be redacted first. Then, information with the second highest score should be the next candidate for redaction. In one embodiment, a content provider may specify a threshold value (e.g., 0.8) for purposes of redacting its content. If content redaction is token based, tokens having normalized scores in [0, 1] above the threshold value may be redacted. Similarly, if the redaction is sentence based, sentences having scores above the threshold value may be redacted.

In another embodiment of the present invention, when the page layout of a document (e.g., page width) is fixed, such as in PDF files, tokens can be indexed by rows and columns. The process 200 may run clustering algorithms (e.g., k-means clustering algorithm) to analyze the density of token scores on a two-dimensional space and determines the parts of the document for redaction based on the distribution of score density.

In another embodiment of the present invention, certain part(s) of the content will always be displayed regardless of the content provider's preference. This configuration may encourage content providers to offer consistent, unique, and valuable information throughout the content, which helps to attract readers.

In one embodiment, tokens, sentences, paragraphs, or sections can be sorted or selected based on percentile. If a percentage level is specified for redaction, the tokens, sentences, paragraphs, or sections whose percentiles are above the specified percentage level would be redacted from the original content.

In one embodiment, the percentage of the content to be displayed may be determined based on how much a customer pays. For example, if the price to view a full article is N and the customer only pays partial price P, the process 300 may redact the tokens, sentences, paragraphs, or sections whose score-based percentiles are above the

$$\frac{P}{N} \times 100 \% .$$

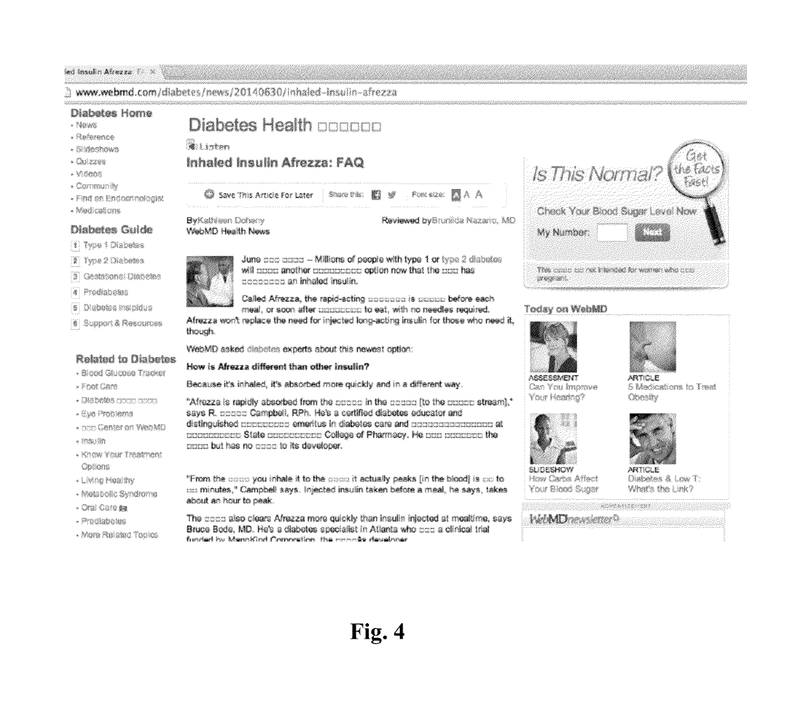

In one embodiment, redacted parts can be replaced with empty block fillers (see FIG. 4) or other signs, such as “information redacted here.” In another embodiment, redacted parts can be removed totally.

In one embodiment, the present invention can be integrated into a subscription system or metered system. Content consumers can log into the system of either the content provider or the content processor that's operating the System 100. In the former case, the consumer needs to maintain a valid account with each content provider. If the subscription is valid, the consumer is not required to make purchase again. In the latter case, once the consumer signs up with the content processor, he/she can purchase the content easily with single sign on, and there is no need for him/her to maintain separate accounts with various content providers.

In another embodiment, this invention can be customized for pay-per-view without creating any account. This is achieved by saving a unique token to the consumer's browser cookie, which allows the content processor to track the consumer's payment status, thus to control the content to be shown to the consumer. The token may be saved in a web browser cookie with predefined expiration date and/or time. It uniquely identifies both the consumer (by using email address or phone number, for example) and the web content (by using a globally unique ID).

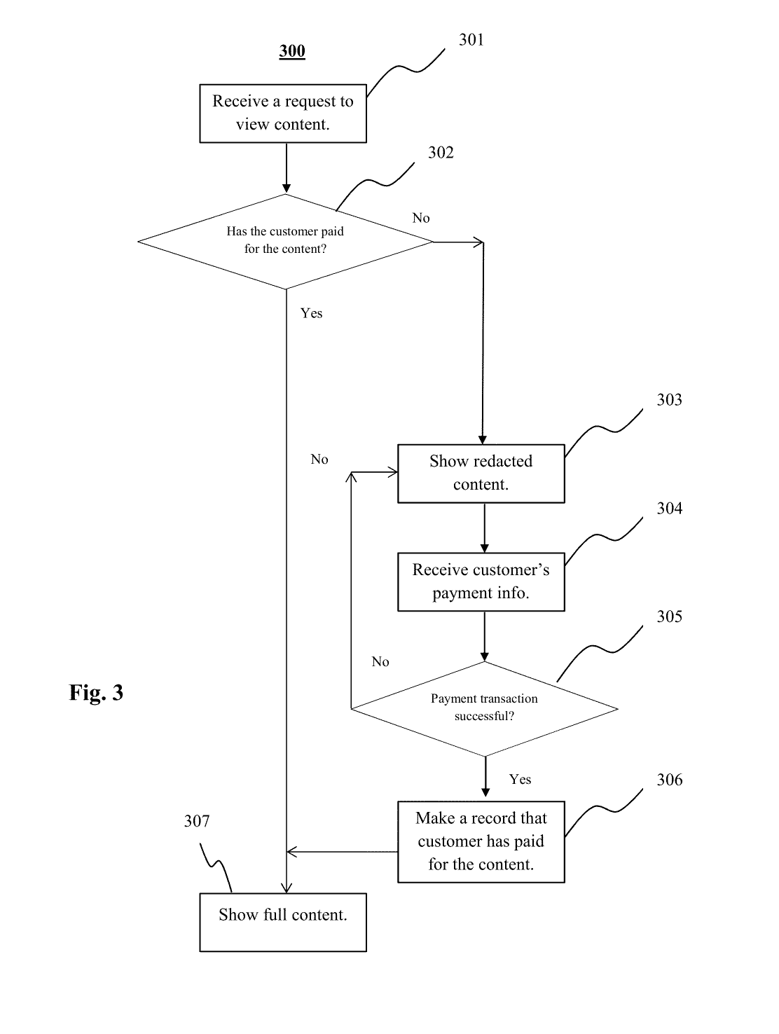

FIG. 3 is a flow diagram showing a process (300) for payment management, according to an embodiment of the present invention. One or more instances of the process 300 may run on the payment management server 102 of the System 100.

At step 301, the process 300 receives a request from a customer to view certain content (e.g., an article). For example, the customer may request to view a web page containing an article, which is subject to the payment process, via a web browser 120. Accordingly, the web browser 120 sends a request to the host server 110 for the content of the web page, including the article. The host server 110 determines that the article is subject to the payment process and then forwards the request to the process 300. As another example, the customer may request to view the content within an application 130. The application 130 then sends a request for the article to the host server 110, which forwards the request to the process 300.

At step 302, the process 300 determines whether the customer has paid for the content. In one embodiment, if the customer's request is from a web browser 120, the process 300 may determine whether the customer has paid for the content by checking whether the cookie, sent as part of the request, contains any payment information. In another embodiment, if the customer has logged into the host server or the System 100, the process 300 checks whether the customer has a paid subscription or the metering cap has not reached yet.

If the customer has paid for the content, the process 300 goes to step 307, where it sends or authorizes the host server 110 to send the full content. Otherwise, the process 300 goes to step 303. At step 303, the process 300 sends or causes the host server 110 to send a redacted version of the content. The redacted version may be created by the process 200. Also, the System 100 or the host server 110 may provide the customer an option (e.g., a button or link) to purchase the content. If the customer activates the button or link, the System 100 or the host server 110 may provide a form for the customer to provide payment information such as name, address, and credit card number, etc. At step 304, the process 300 receives the payment information. At step 305, the process 300 uses the payment information to conduct a transaction. If the transaction is successful, the process goes to step 306, where the process 300 makes a record that the customer has paid for the content. If the transaction fails, the process 300 goes to step 303.

From step 306, the process 300 goes to step 307, where it sends or causes the host server 110 to send the full content (i.e., the non-redacted version).

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A computer-implemented method for redacting digital content in an online monetization process, the method comprising:
extracting text information from the digital content;
generating a plurality of tokens from the text information;
calculating a token score for each token based on a plurality of feature values of the respective token, wherein the plurality of feature values comprise at least two of an intra-token feature value, an inter-token feature value, an extra-token feature value, and a tagged-token feature value; and
redacting a portion of the digital content based on the token scores.

2. The computer-implemented method of claim 1, wherein the digital content comprises an electronic document.

3. The computer-implemented method of claim 2, wherein the token score for each token is normalized into [0, 1], and wherein the redacting step comprises:
comparing the token score of each token with a predetermined threshold value; and
redacting the respective token if the token score of the token is greater than the predetermined threshold value.

4. The computer-implemented method of claim 3, wherein the intra-token feature value of each token is determined based on entropies of letters in the respective token, the inter-token feature value of each token is determined based on an estimated importance of the respective token in a corresponding context calculated by an automatic keyword extraction tool, the extra-token feature value of each token is determined based on whether the respective token is in a first set of preselected tokens, and the tagged-token feature value of each token is determined based on whether the respective token is in a second set of preselected tokens.

5. The computer-implemented method of claim 4, wherein the first set of preselected tokens comprises a plurality of words of general public interest.

6. The computer-implemented method of claim 4, wherein the second set of preselected tokens comprises a plurality of words selected by a content provider of the digital content.

7. The computer-implemented method of claim 1, further comprising:
calculating a score for each of a plurality of language elements of the text information based on the token scores; and
normalizing the score of each language element into [0, 1].

8. The computer-implemented method of claim 7, wherein the redacting step comprises:
comparing the normalized score of each language element with a predetermined threshold value; and
redacting the respective language element if the normalized score of the language element is greater than the predetermined threshold value.

9. The computer-implemented method of claim 8, wherein the plurality of language elements is one of a plurality of sentences, a plurality of paragraphs, a plurality of sections, and a plurality of chapters.

10. The computer-implemented method of claim 1, further comprising calculating a percentile for each token based on the respective token's token score, and wherein the redacting step comprises redacting the respective token if the percentile of the token is greater than a predetermined threshold.

11. A system for redacting digital content, the system comprising:
a memory for storing instructions; and
a processor which, upon executing the instructions, performs a process comprising:
extracting text information from the digital content;
generating a plurality of tokens from the text information;
calculating a token score for each token based on a plurality of feature values of the respective token, wherein the plurality of feature values comprise at least two of an intra-token feature value, an inter-token feature value, an extra-token feature value, and a tagged-token feature value; and
redacting a portion of the digital content based on the token scores.

12. The system of claim 11, wherein the calculating step further comprises normalizing the token score for each token into [0, 1], and wherein the redacting step comprises:
comparing the normalized token score of each token with a predetermined threshold value; and
redacting the respective token if the normalized token score of the token is greater than the predetermined threshold value.

13. The system of claim 12, wherein the intra-token feature value of each token is determined based on entropies of all letters in the respective token, the inter-token feature value of each token is determined based on an estimated importance of the respective token in a corresponding context calculated by an automatic keyword extraction tool, the extra-token feature value of each token is determined based on whether the respective token is in a first set of preselected tokens, and the tagged-token feature value of each token is determined based on whether the respective token is in a second set of preselected tokens.

14. The system of claim 13, wherein the first set of preselected tokens comprises a first plurality of words of general public interest, and the second set of preselected tokens comprises a second plurality of words selected by a content provider of the content.

15. The system of claim 11, wherein the process further comprises calculating a score for each of a plurality of language elements of the text information based on the token scores, and wherein the redacting step comprises redacting the portion of the content based on the scores of the plurality of language elements.

16. The system of claim 15, wherein the plurality of language elements is one of a plurality of sentences, a plurality of paragraphs, a plurality of sections, and a plurality of chapters.

17. The system of claim 11, wherein the process further comprises calculating a percentile for each of a plurality of sentences of the text information based on the token scores, and wherein said redacting step comprises redacting the respective sentence if the percentile of the sentence is greater than a predetermined threshold.

18. A computer-readable medium having computer-executable instructions stored thereon which, when executed by a computer, cause the computer to:
generate a plurality of tokens from an electronic document;
calculate a token score for each token based on a plurality of feature values of the respective token, wherein the plurality of feature values comprise at least two of an intra-token feature value, an inter-token feature value, an extra-token feature value, and a tagged-token feature value, and wherein the intra-token feature value of each token is determined based on entropies of all letters in the respective token, the inter-token feature value of each token is determined based on an estimated importance of the respective token in a corresponding context calculated by an automatic keyword extraction tool, the extra-token feature value of each token is determined based on whether the respective token is in a first set of preselected tokens, and the tagged-token feature value of each token is determined based on whether the respective token is in a second set of preselected tokens; and
redact parts of the electronic document based on the token scores.

19. The computer-readable medium of claim 18, wherein said redact step comprises:
determine a percentage value based on a customer's payment amount over a full payment amount needed for viewing the whole portion of the electronic document;
calculate a percentile for each token based on the respective token's token score; and
redacting the respective token if the percentile of the token is greater than the percentage value.

20. The computer-readable medium of claim 18, wherein said redact step comprises replace the parts of the electronic document with empty block fillers.
